(19) United States
(12) Patent Application Publication
(10) Pub. No.: US 2006/0156612 A1
(43) Pub. Date: Jul. 20, 2006

(54) Bottom fish rigs with fish hooks

(76) Inventor: Frank T. Brzozowski, (US)

Correspondence Address: FRANK T. BRZOZOWSKI, 2357 E. Dauphin Street, Philadelphia, PA, 19125, US

(21) Appl. No.: 11/385,237

(22) Filed: Mar. 21, 2006

Related U.S. Application Data
(63) Continuation-in-part of application No. 10/724,859, filed on Nov. 30, 2003.

(51) Int. Cl. A01K 91/00

(52) U.S. Cl. 43/43.15; 43/43.1

(57) ABSTRACT

The bottom fish rig with fish hooks 10 has a sinker attachment means of securing weight upon a leader 13 with small wire loops 18 and 20 and a fish hooking means. An elongated leader 13 has a hook end 14 and a line end 16. The hook end 14 has a leader hook loop 18 and fish hook 50. The leader line end 16 has a leader line loop 20. A first movement stop 22 is crimped to the leader 13 before the leader line loop 20. A second movement stop 24 is crimped to the leader about two-thirds of the length. A sliding c-weight 25 connects to the leader 13 between movement stops.

### CROSS REFERENCE TO RELATED APPLICATIONS

| | | |
|---|---|---|
| Country -Number | MM-YYYY | Name Classification |

U.S. Patent Documents

| | | |
|---|---|---|
| U.S. Patent No. 6,770,295 | 08-2004 | Davidson, Lawrence P. 43/43.16 |
| U.S. Patent No. 6,739,085 | 05-2004 | Burczynski, Michael J. 43/43.16 43/43.4 |
| U.S. Patent No. 6,691,449 | 02-2004 | Hoben, Donald M 43/43.16, 434/43.2 |
| U.S. Patent No. 6,655,075 | 12-2003 | Bohn, Greg 43/43.6 |
| U.S. Patent No. 6,640,489 | 11-2003 | Rigney, Jan J. 43/42.37 |
| U.S. Patent No. 6,560,917 | 05-3002 | Van Der Hoven, et al 43/43.4, 43/43.16, 43/37 |
| U.S. Patent No. 6,526,690 | 03-2003 | Dillard, Michael C. 43/4, 269/907 |
| U.S. Patent No. 6,519,895 | 02-2003 | Bennett, Thomas J. 43/44.81 43/42.39, 43/43.16 |
| U.S. Patent No. 6,497,068B1 | 12-2002 | Lemons, John D. 43/36 |
| U.S. Patent No. 6,325,136 | 12-2001 | Ratte, Geoffrey S. 164/129, 164/131 |
| U.S. Patent No. 6,305,121 | 11-2000 | Adams, Nicholas S. 43/44.96, 43/43.1 |
| U.S. Patent No. 6,170,191 | 01-2001 | Laney, Scot H. 43/43.13 43/44.9 |
| U.S. Patent No. 6,145,240 | 06-1999 | Adams, Nicholas S. 43/44.96 |
| U.S. Patent No. 6,076,297 | 06-2000 | Lippincott, Robert 43/44.87, 43/44.91 |
| U.S. Patent No. 6,073,386 | 06-2000 | Firmin, Herman P. 43/44.87, 43/44.9 |
| U.S. Patent No. 6,067,942 | 05-2000 | Fernandez, John Barnard, 119/802 |
| U.S. Patent No. 6,047,493 | 04-2000 | Strampe, Clarence W. 43/44.96, 43/44.97, 43/44.87 |
| U.S. Patent No. 5,946,849 | 09-1999 | Brown, John E. 43/44.89 43/43.1 |
| U.S. Patent No. 5,918,408 | 07-1999 | Laney, Scot H. 43/43.13 43/44.9 |
| U.S. Patent No. 5,887,381 | 03-1999 | Stephenson, Timothy L. 43/43.15 |
| U.S. Patent No. 5,878,525 | 03-1999 | Metzler, Norman P. 43/43.1, 43/44.94 |
| U.S. Patent No. 5,752,961 | 05-1998 | Hill, Bradley B. 606/113 606/110 |
| U.S. Patent No. 5,678,351 | 10-1997 | Halterman, Jr., Danny R. 43/43.1 |
| U.S. Patent No. 5,673,508 | 10-1997 | Snyder, Gary 43/42.37, 43/44.8, 43/44.82 |
| U.S. Patent No. 5,386,660 | 02-1995 | Levin, John M. 43/43.16 43/44.82 |
| U.S. Patent No. 4,914,852 | 04-1990 | Hnizdor, Thomas A 43/44.82 |
| U.S. Patent No. 4,785,509 | 11-1988 | Fisher, Sidney L.; 24/129R |
| U.S. Patent No. 4,696,125 | 09-1987 | Raybum, Walter 43/43.14 |
| U.S. Patent No. 4,209,933 | 07-1980 | Manno, Joseph T. 43/43.15 |
| U.S. Patent No. 3,701,212 | 10-1972 | Gilliam, Joe L. 43/44.87 |
| U.S. Patent No. 3,118,245 | 01-1964 | Shriver, Lloyd L. 43/43.15 |
| U.S. Patent No. 3,096,599 | 07-1963 | Baron, Charles 43/44.9 |
| U.S. Patent No. 2,766.549 | 10-1956 | Dickerson, William 43/44.98 |
| U.S. Patent No. 2,703,947 | 03-1955 | Petrasek et. al. 43/42.39 |
| U.S. Patent No. 2,177,007 | 10-1939 | Smith, Wallace E. 43/44.88 |
| U.S. Patent No. 2,019,630 | 11-1935 | Peeso, Martin E. 43/43.11 |
| U.S. Patent No. 1,883,574 | 10-1932 | Cleeland, John S. 43/43.1 |
| U.S. Patent No. 1,208,936 | 12-1916 | England, Henry 43/43.1 |
| U.S. Patent No. 10/724,859 | 03-2006 | Brzozowski, Frank T. 43/43.15 |
| D469,502 S | 01-2003 | Shelton, Billy R. |
| D458,982 S | 06-2002 | Ratte, Geoffrey S. D22/145 |

Foreign Patent Documents

| PCT/US2003/038034 | 11-2003 | Brzozowski |
|---|---|---|
| Canada No. US2003038034 | 05-2005 | Brzozowski |
| Australia No. 2003298750 | 06-2005 | Brzozowski |
| New Zealand No. 5450975 | 06-2005 | Brzozowski |
| EPO No. 03796508.4-2321 | 06-2005 | Brzozowski |
| Publications | | |

| | |
|---|---|
| PCT Publication No.: | WO 2004/049788 A3 |
| US Publication No.: | US 2004/0107629 A1 Jun. 10, 2004 |

### OTHER REFERENCES

Bass Pro Shops®, Bass Pro Outdoors Online LLC, www.basspro.com

Budworth, Geoffrey. “The Complete Book of Knots,” Octopus Publishing Group Ltd© 1997. p. 64, 118,

Cabela's® Master Catalog, Cabela's Inc., www.cabelas.com

“Grays of Kilsyth,” email John@graysofkilsyth.com.

Luckey, Carl F, and Harbin, Clyde, Sr. “Warman's® Fishing Lures Field Guide,” ISBN 0-87349-692-2 Kraus Publication Inc.,© 2003.

Pfeiffer, C. Boyd. “The Field and Stream Baits and Rigs Handbook,” ISBN 1-55821-883-1, The Lyons Press© 1999.

Shaw, John. “The Directory of Knots,” The Ivy Press Limited, ISBN 0-7858-1629-1, 2003. p. 138

### PARENT CASE TEXT AND RELATED APPLICATIONS

This application, the “Bottom Fish Rigs with Fish Hooks” is also related to a continuation-in-part patent application filed on Mar. 17, 2006, under the title of “Horizon Unilateral Fish Hook,” and is related to a continuation-in-part patent application filed on Mar. 10, 2006, under the title of “Sliding C-weight;” this application is a continuation-in-part of U.S. patent application Ser. No. 10/724,859 filed on Nov. 30, 2003, entitled “Bottom Fish Rig:” The entire contents of the parent application is incorporated herein by reference. This application incorporates and is based on provisional application No. 60/430,325, filed on Nov. 30, 2002 which cited the Document Disclosure Deposit Request No. 504577 filed on Jan. 28, 2002; the entire contents of which are incorporated by reference.

### BACKGROUND OF THE INVENTION

1. Field of the Invention

This immediate patent, the bottom fish rigs with fish hooks, has various embodiments, a strong leader with a notable new sliding c-weight and fishing rigs with small loops or loops that close and resists snagging. The present invention is useful, new and has particular utility in connection with fishing tackle by having appearance and features different from other fishing tackle, such as snelled hooks and commercial rigs for specific fish.

Therefore, a need exists for a new and improved bottom fish rig which can be used for fishing tackle having new sliding c-weight and fishing rigs with small loops or loops that close and resists snagging. In this regard, the present embodiment of the invention substantially fulfills this need. Moreover, the bottom fish rig, according to the present embodiment of the present invention substantially departs from the conventional concepts and designs of the prior art, and in doing so provides an apparatus primarily developed for the purpose of fishing by having a notable new sliding c-weight and fishing rigs with small loops or loops that close and resists snagging and ability to use different hooks including the unique horizontal unilateral fish hooks that lies upright horizontally on the bottom of a waterway and resists snagging.

2. Description of the Prior Art

The bottom fish rigs with fish hooks is novel by being versatile, and having a notable new sliding c-weight and fishing rigs with small loops or loops that close and resists snagging and ability to use different hooks including the unique horizontal unilateral fish hooks that lies upright horizontally on the bottom of a waterway and also resists snagging as well as being able to combine components with fishing tackle on the market.

A patent search, an investigation of bait stores, sporting goods stores, internet catalogues and fishing books did not find or reveal similar bottom fish rigs with fish hooks. One product has a rig with an egg sinker with movable red beads, however, the spin-able red beads are not stationary and fixed upon the line like a movement stop in this invention. The bottom fish rigs with fish hooks employ single hooks; however, other type of hooks could be used including the horizontal unilateral fish hook that are new, unique and performs differently from the usual fishing tackle that is used: double hooks, treble hooks, combination hooks and hooks in rigs.

In the prior art the patents displayed or illustrated do not have an embodiment like a horizontal unilateral fish hook. Patents for single fish hooks were not individually examined since the present invention is unlike any single fish hook. However, single fish hooks appear to be numerous and it is amazing that patents have been issued for different hooks with subtle differences. Many types of single barb fishhooks exist; some of the manufactures are Mustad,® Eagle Claw,® Gamakatsu,® Matzuo Hooks, VMC,® Cabela's,® Bass Pro Shops® Extreme Performance Series XPS™, Bleeding Bait Hooks and King Kat™ Circle Hooks are currently available as well as products of many earlier fish hook manufacturers that have went out of business or were purchased by larger companies.

Presently, VMC manufactures at least 10 models of single hooks and 2 treble hooks. Matzuo Hooks is a company that manufactures at least 11 single hooks and 3 treble hooks. Bleeding Bait Hooks is a company that has different models of single hooks: Offset Worm Hook, Fatgap™ Tube Hook, Offset—wide gap, Copperhead 60°, Drop Shot Hook and Wacky Hook™.

Gamakatsu,® manufactures many models of single hooks: Octopus—bronze, nickel, green and red, Offset Shank EWG, Split Shot Hook, Walleye Wide Gap, Round Bend Worm, Weedless Worm Hook, Straight Eye Shiner, G-Lock Worm Hook, Jig Hook 90°, Offset Worm Hook, Offset Round Bend, Open Eye Siwash, G. Stinger, 60° Flat Eye jig, 90° Jig—Heavy wire, Octopus Circle, G-mag Worm, and Superline Worm Hooks.

Eagle Claw® has many single hooks, Black Pearl Aberdeen, Salmon Egg Sliced shank, Plain Shank, Bait holder, Baitholder—ringed eye, Aberdeen—plain shank ringed eye, Extra light Aberdeen, Aberdeen extra-lite wire, O'Shaughnessy x-strong stainless steel, Weedless, Lazer Sharps Jig Hook red, Aberdeen Jig Hook—90,° Lazer Sharp® Salmon Egg Baitholder, Lazer Sharp Wide Bend—Extra-wide gap, Lazer Sharp® Teflon light wire, Lazer Sharp® Khale Ring eye, Lazer Sharp® Khale Horizontal—wide open gap upturned eye, Lazer Sharp® Steelhead—upturned eye, Lazer Sharp® Salmon/Steelhead red, Lazer Sharp® Octopus style, and Lazer Sharp® Snelled Salmon Red.

Advancing beyond the crowded art of the single hooks, the double hooks and treble hooks are items of interest. The horizontal unilateral fish hooks have characteristics that are novel and new in comparison to the double and treble hooks available presently. The artwork and functions of the horizontal unilateral fish hooks are different from the hooks in the prior art. F. C. Woods patented detachable double and treble hooks which resemble the common treble hooks, but with a space between two shanks. Most of the treble hooks look similar with slight differences. Some of the treble hooks found are: Eagle Claw® manufactures a Lazer Sharp® Treble red, Treble—Hollow ground points brazed, and Lazer Sharp Treble—hollow ground point; Gamakatsu manufactures an Extra-Wide Gap Treble and Round Bend Treble; Matzuo manufactures model BE-11-8515, BE-11-8529, and a weedless treble hook BE-11-8514; VMC makes Model 9617GO and 9617BZ. Most patents for treble hooks and double fish hooks were not individually examined since the present invention is unlike any of those fish hooks. The new horizontal unilateral fish hooks are designed to stay elevated as it drops horizontally on the bottom of a waterway with bait, due to a novel placement of the fish hook eye and weight of the shank.

The double hooks of some interest are the VMC 9508 double hook, and the Gamakatsu Frog Hook which are not welded and are predominately used as a replacement hook in lures. The two double hooks seem to have two independent shanks, while the horizontal unilateral fish hook has the shanks solidly joined together. A horizontal unilateral fish hook is designed to lie horizontally on the floor of a body of water. When the fishing line is jerked, the force toward the eye causes a horizontal unilateral fish hook to flip upright; however, when baited, the VMC, Gamakatsu® frog hook and similar double hooks become top heavy land on the bottom of waterways upside down; their barbs could snag onto objects. Another difference is the location of the eye. In the VMC, Gamakatsut and other double hooks, the eye is in the same plane as the shank; in contrast to the horizontal unilateral fish hook whose eye is designed to be elevated by the solidly joined and slanted shank.

Another double hook that relates to this invention is the Mustad® Double Live Bait Hook which has a bendable pin between the barbs of the double hook that extends the length of the hook to slightly beyond the eye. The double live bait hook has a safety pin latch at the base of the eye that holds the point of the pin at one end and the shanks of the two double hooks are connected to the other end of the pin. In the prior art, the Mustad® Double Live Bait Hook is very similar to a component of the patent issued to Shriver in 1962.

The bait positioning fishing device U.S. Pat. No. 3,118,245 was issued to Shriver. The artwork looks like a large cross with long thin rods, a sinker is attached at one end to a rod and fish hooks soldered to the same rod at the other end. Both the Shriver patent and the Mustad® Double Live Bait hook have latch a distance away from the barbs that secures bait with a pin or rod. Although Shrivers' patent has two hooks soldered to a rod, the invention has many components that are different than the horizontal unilateral fish hook which is more compact, has a different appearance and is designed to resist snagging. A disadvantage of the Shriver patent, the Mustad® Double Live Bait Hook and the Gamakatsu® frog hook is that once bait is inserted upon the hooks, the combination could become top-heavy and the barbs of the hooks could actually be pointing downward and become snagged onto objects.

This disadvantage might also occur to the Automatic fishhook by Lemons, U.S. Pat. No. 6,497,068 which is a one piece double hook that has two legs that have barbs connected to a torsion spring that resembles a spring with 2 fishing hooks on the ends; Lemons' patent does not resemble the fishing hooks in stores nor does it resemble a horizontal unilateral fish hook.

Additionally, U.S. Pat. No. 5,022,178 to Carlson, discloses a fishing rig for live or artificial bait with a bendable member mounted between at least two hooks, particularly treble hooks; the hooks being mounted with respect to a leader such that when one hook is set in a fish, the bendable member bends upon a pull of the leader and the other hook moves toward the set hook. The bending of the bendable member forces the other hook into a set condition and enlarges the transverse width of the rig within the fish so that a double hooking action is guaranteed. However, the Carlson '178 patent has a different mechanical function and is unlike a horizontal unilateral fish hook that resists snagging.

Further, U.S. Pat. No. 4,888,910 to Lewis discloses an adjustable snelled hook assembly comprises a fishing line with a trailing hook secured thereto. An auxiliary hook has a shank, a barb and an eye loosely and slidably mounted upon the fishing line adjustably spaced from the trailing hook. A coil spring is mounted upon the shank and is generally parallel to the fishing line. A plurality of continuous windings of the line extend around, and snugly engage, the spring and shank to anchor the auxiliary hook upon the fishing line. However, the Lewis '910 patent does not have a horizontal unilateral fish hook that resists snagging.

Yet further, U.S. Pat. No. 5,673,508 to Snyder discloses a beaded fishing lure having a weighted body molded to a fish hook and including a beaded trailer hook. A flapper piece oscillates with lure movement about a projecting extension of the hook shank to strike the body and produce audible sound. The flapper is secured to the body with a split ring at aligned apertures and from a slot which mounts about the hook extension. The eye of the trailer hook is secured to the shank of the primary hook and a bead is molded to the trailer hook. A variety of dressings mount to the bead including multi-filament skirts and molded plastic tails. However, the Snyder '508 patent does not have a horizontal unilateral hook that resists snagging.

Lastly, U.S. Pat. No. 5,386,660 to Levin discloses a fishing hook with curved barb that is resistant to accidental dislodgement from the mouth of a fish, yet which does not pose a snagging hazard to persons handling it. The hook comprises a shank portion, at least one bent return portion, and a barb at the upper end of the return portion. The return portion of the hook has a longitudinal axis which is generally parallel to the longitudinal axis of the shank. The barb terminates in a sharply pointed free end contiguous with a generally semi-tear-drop shaped, relatively blunt, edge surface. That edge surface includes a curved portion spaced laterally of the longitudinal axis of the return portion of-the hook and a contiguous undercut portion merging with the return portion of the hook. The curved portion of the edge surface may be directed toward or away from the shank of the hook. However, the Levin '660 patent does not have a horizontal unilateral fish hook that resists snagging.

While the above-described devices fulfill their respective, particular objectives and requirements, the aforementioned patents do not describe an invention that functions and is shaped like the horizontal unilateral fish hook, which is basically more compact, simple to apply in the field, and to manufacture. Beside the prior art and aforementioned patents, the present invention has components that are nonobvious, novel, useful, and an improvement over other inventions in the field. A horizontal unilateral fish hook is novel by itself individually and when used as a component in the parent invention, the bottom fish rig.

### SUMMARY OF THE INVENTION

The bottom fish rigs with fish hooks, have various embodiments with notable and new components making them unique. The bottom fish rigs have their characteristic identity by fixing 2 weight stops onto the leader of the invention that limits the movement of sliding sinkers or weights; by using the new sliding c-weight, by creating fishing rigs with small loops or loops that close and resists snagging, and ability to use different hooks, and by the ability to utilize new embodiments, including the unique horizontal unilateral fish hooks which lie upright horizontally on the bottom of a waterway, and resists snagging, as well as using single hooks and conventional fishing tackle.

In view of the foregoing disadvantages inherent in the known types of fishing tackle now present in the prior art, the present embodiment of the invention provides improved bottom fish rigs with fish hooks, including the ability to employ the horizontal unilateral fish hooks, as well as single hooks and other conventional fishing tackle that overcomes the above-mentioned disadvantages and drawbacks of the prior art. As such, the general purpose of the present embodiment of the invention, which will be described subsequently in greater detail, is to provide a new and improved horizontal unilateral fish hook, individually, and as a component of a bottom fish rig, which has all the advantages of the prior art mentioned heretofore and many novel features that result in a horizontal unilateral fish hook which is not anticipated, rendered obvious, suggested, or even implied by the prior art, either alone or in any combination thereof.

The prior art of record neither discloses nor fairly teaches the recited limitations of the claimed combination including, but not limited to a c-weight, individually, or as a component of the present patent, the bottom fish rigs with fish hooks. There has thus been outlined, rather broadly, the more important features of the embodiment of the invention in order that the detailed description thereof that follows may be better understood and in order that the present contribution to the art may be better appreciated. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

### OBJECTS AND ADVANTAGES

It is therefore an object of the present embodiment of the invention to provide a new and improved horizontal unilateral fish hook that has all of the advantages of the prior art fishing tackle and none of the disadvantages.

It is another object of the present embodiment of the invention to provide a new and improved bottom fish rigs with fish hooks that may be easily and efficiently manufactured and marketed.

An even further object of the present embodiment of the invention is to provide a new and improved horizontal unilateral fish hook that has a low cost of manufacture with regard to both materials and labor, and which accordingly is then susceptible of low prices of sale to the consuming public, thereby making such bottom fish rigs with fish hooks economically available to the buying public.

Still another object of the present embodiment of the invention is to provide a new bottom fish rigs with fish hooks that provides in the apparatuses and methods of the prior art, some of the advantages thereof, while simultaneously overcoming some of the disadvantages normally associated therewith.

Another object of the present embodiment of the bottom fish rigs with fish hooks is its novel features, consisting of attributes that most other fishing hooks do not possess; it has loops that close and resists snagging by preventing objects from sticking in the loops.

Another object of the present embodiment of the bottom fish rigs with fish hooks is to be fairly compact and to have small loops on wire leaders, and preset open loops that are able to close upon using leaders of monofilament fishing line.

Yet another object of the bottom fish rigs with fish hooks is the ability to use single hooks, double hooks, treble hooks and the new horizontal unilateral fish hook is to be used independently on a fishing line or made as a component of a fishing rig.

An object of the present invention is to provide a useful and unique bottom fish rigs with fish hooks with at least one fish hook and a sliding weight, but rigs are able to improvise and use other fishing tackle thus causing the rigs to slide smoothly and avoid snags while being used.

Another object of the bottom fish rigs with fish hooks in this invention is to be easily installed without any tool, and when it is used with a snap and swivel it can be attached and removed from the fishing line quicker than the common fishing hooks without cutting the fishing line or the leader to which it is attached.

Another object of the present invention is to create a bottom fish rig with a sinker attachment means made of various metals or alloys, including but not limited to iron, tungsten, zinc plating, or stainless steel compounds.

Even still another object of the present embodiment of the invention is to provide a bottom fish rig with single fish hooks; yet double hooks, treble hooks and horizontal unilateral fish hook could be employed having various sizes, shapes and styles and is still another object of the present embodiment of the invention.

Another object of the bottom fish rigs with fish hooks in this invention is to be easily installed without any tool, and when it is used with a snap and swivel it can be attached and removed from the fishing line quicker than the common fishing hooks without cutting the fishing line or the leader to which it is attached.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be made to the accompanying drawings and descriptive matter in which there are illustrations of the preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a side view of the first embodiment of the bottom fish rig with fish hook of the invention.

FIG. 2 is a side view of the second embodiment of the bottom fish rig with fish hook of the invention.

FIG. 3 is a side view of the third embodiment of the bottom fish rig with fish hook of the invention.

FIG. 4 is a side view of a third embodiment of a bottom fish rig with fish hook of the present invention.

FIG. 5 is a side view of a fourth embodiment of a bottom fish rig with fish hook of the invention.

FIG. 6 is a side view of the sixth embodiment of bottom fish rig with fish hook of the invention.

The same reference numerals refer to the same parts throughout the various figures.

### DETAILED DESCRIPTION OF THE INVENTION

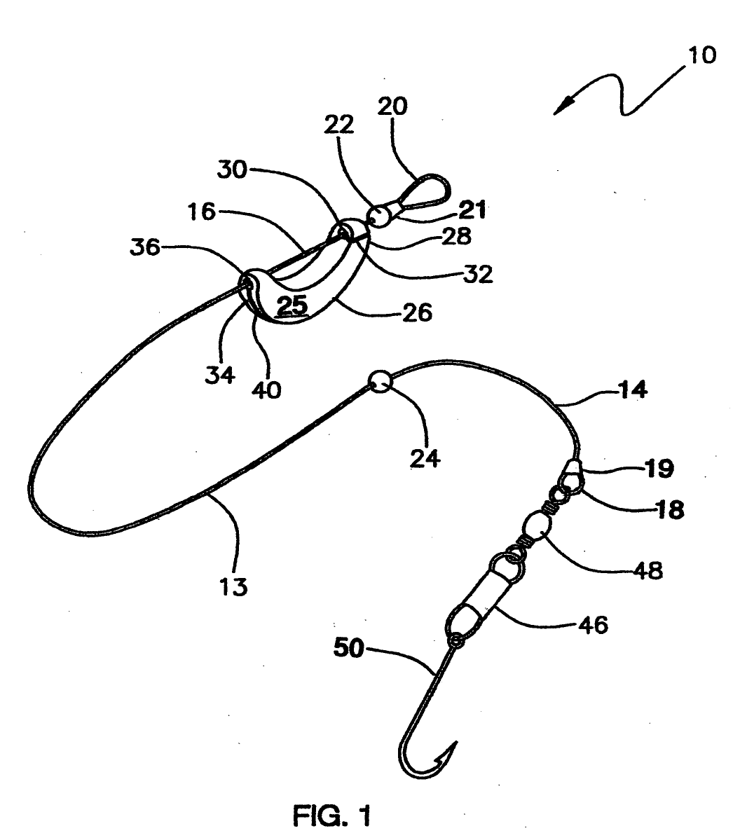

Referring now to the drawings, and particularly to FIGS. 1 to 6, a preferred embodiment of the present invention, the bottom fish rig with fish hooks, is shown and generally designated by the reference numeral 10.

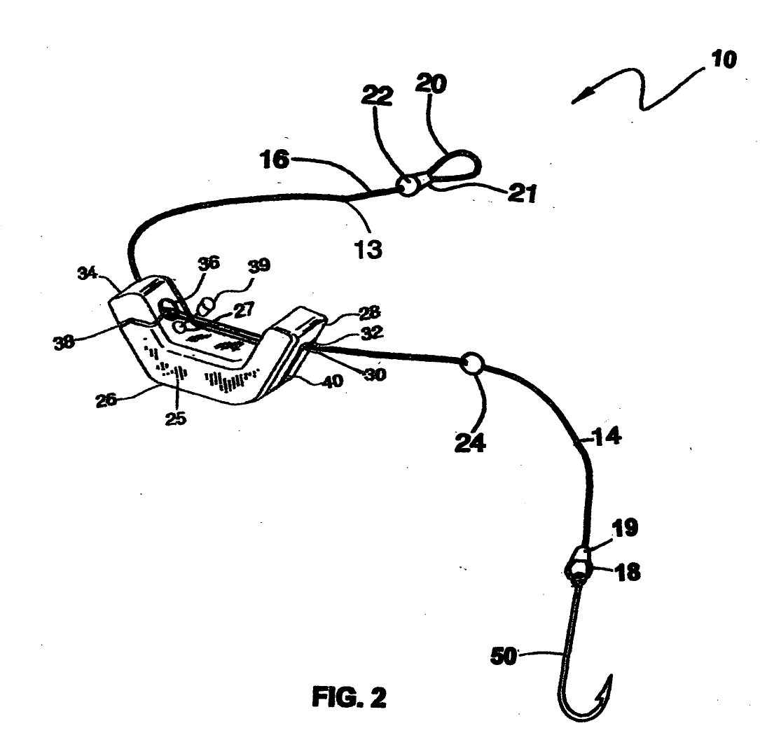

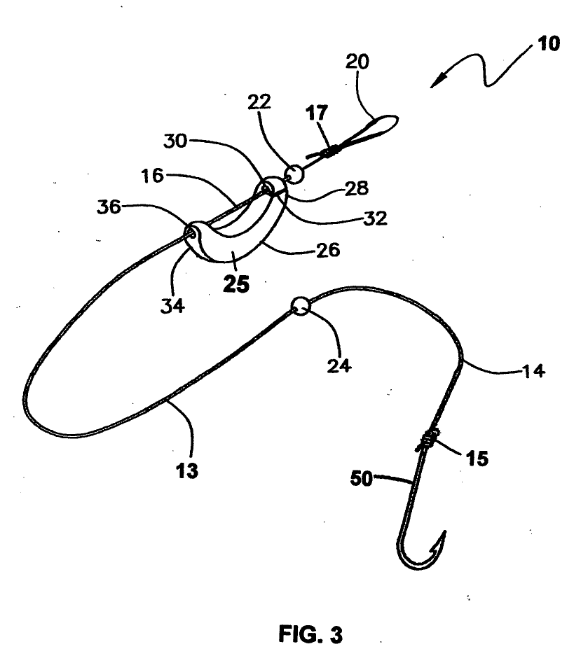

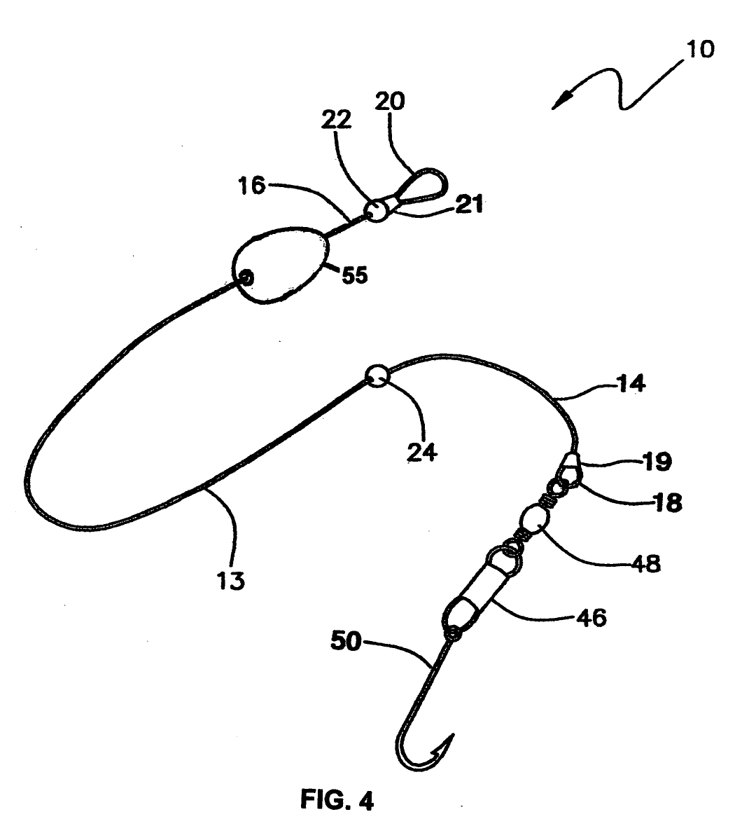

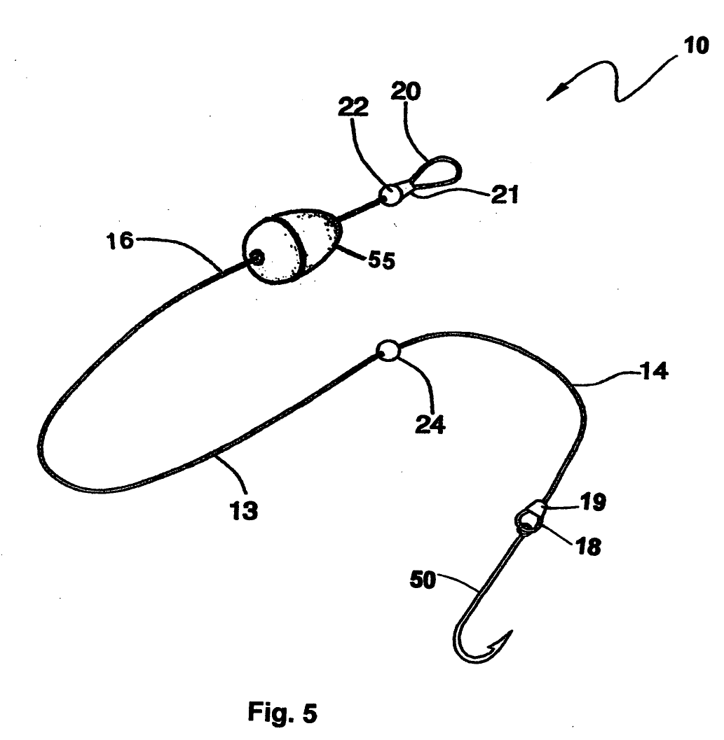

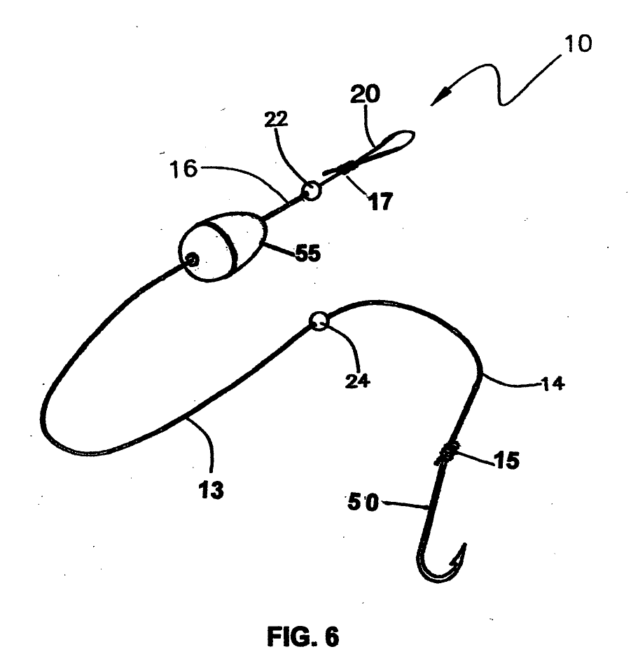

The bottom fish rigs with fish hooks 10 in FIG. 1 to FIG. 6 have some common components: a wire leader 13, a leader line loop 20, two movement stop 22 and 24, a leader line end 16 is an area for the movement of a sinker attachment means and a leader hook end 14 is a area that the sinker attachment means is prohibited. A fish hooking means includes a single hook 50, a double hook, a treble hook or a horizontal unilateral fish hook with 2 or 3 horizontal prongs. FIG. 1 to FIG. 3 have a sliding c-weight 25 and a single hook 50. FIG. 4 to FIG. 6 have an egg-sinker 55 as the sinker attachment means attached with a single hook 50. FIG. 1 and FIG. 4 have snaps 46 and swivels 48; FIG. 2 and FIG. 5 do not have snaps and swivels; and FIG. 3 and FIG. 6 have monofilament fishing lines with opened loops 20 with slip knots 17. FIGS. 1, FIG. 2, FIG. 4 and FIG. 5 have wire leaders 10 with loops formed by crimping metallic lugs 19 and 21.

The first embodiment of the present invention FIG. 1 has a new and improved bottom fish rig with fish hook 10 for fishing tackle with a removable sliding c-weight 25 and as a fish hooking means, a single hook 50 that is illustrated and will be described. More particularly, a bottom fish rig with a fish hook 50 has an elongated leader 13 that has two opposite ends, a leader hook end 14 and a leader line end 16. A leader hook end 14 has a leader hook loop 18 that is held securely by a crimped hook loop lug 19 therein: said metallic lugs are crimped over 2 wire strands forming a loop. A leader line end 16 has a leader line loop 20 that is attached to the fishing line from a fishing rod. A line end 16 has a leader line loop 20 that is held securely by a crimped line loop lug 21 therein. A first movement stop 22 is frictionally connected to said leader 13 adjacent said leader line end 16, said first movement stop 22 is comprised of means of obstructing any passage beyond that point with a fixed object such as a crimped split shot, said first movement stop 22 is inserted near the leader line loop lug 21.

The second movement stop 24 is located approximately two-thirds of the distance of the bottom fish rig 13 and located between the line leader loop 20 and at the other end the leader hook loop 18. The second movement stop 24 is comprised of a crimped split shot. The second movement stop 24 is located on the leader 13 approximately one-third of the distance from the leader hook end 14.

In FIG. 1 a removable sliding c-weight 25 is a sinker attachment means of securing weight upon the leader which is attached to the leader 13 and is enable to slide freely two-thirds of the length of the leader 13 to the movement stop 24. The c-weight 25 has substantially the c-shape with three main sections, a first end 28, a c-weight hull 26, and a second end 34. The c-weight 25 has a first end 28 with a first bore therethrough 30. The c-weight 25 has a c-weight hull 26 in the central and lower middle section with a longitudinal groove 40. A longitudinal groove 40 extending across the outside of the bottom of the hull 26 and it is a shallow central semi-cylinder groove that connects with the first end 28 and the second end 34. The c-weight 25 has second end 34 with a second bore therethrough 36. The c-weight 25 has a first slot 32 connected to a first bore 30. The c-weight 25 has a second slot 38 as shown in FIG. 2 connected to a second bore 36. The c-weight 25 has a longitudinal groove 40 therein for allowing the c-weight to be fixedly connected to the leader 13.

Again in FIG. 1 one-third of the bottom fish rigs with fish hooks 10 is a leader hook end 14. A swivel 48 is connected to the leader hook loop 18 by running the leader through the eye of the swivel 48 and having it secured by a crimped metallic hook loop lug 19. A snap 46 is connected to the swivel 48 for a fish hooking means which includes a single hook 50, a double hook, a treble hook or a horizontal unilateral fish hook with 2 or 3 horizontal prongs. A fish hook 50 is attached with a snap 46 to a leader hook end 14.

FIG. 2 is the second embodiment which has an elongated leader 13 having two opposite ends, a leader hook end 14 and a leader line end 16, said hook end having a leader hook loop 18 secured by a metallic leader hook loop lug 19 therein, said leader line end having a leader line loop secured by a leader line loop lug 19, metallic lugs are crimped and fixably attached to a wire leader therein, said metallic lugs are crimped over 2 wire strands forming a loop. A first movement stop 22 is frictionally connected to said leader adjacent said line end, said first movement stop is comprised of means of obstructing any passage beyond that point with a fixed object such as a crimped split shot, said first movement stop 22 is inserted near the leader line loop lug 21. A second movement stop 24 frictionally connected to said leader 13, said second movement stop 24 located between said first movement stop 22 and said leader hook end 14, said second movement stop 24 is comprised of a means of obstructing further movement of by the sinker. Said second movement stop 24 is located approximately one-third of the way from said leader hook end 14, and approximately two-thirds of the distance from the line leader loop 20. A removable sliding c-weight 25 is a sinker attachment means of securing weight upon the leader 13; and a fish hook 50 is a fish hooking means that is pre-attached to the leader hook loop lug 19. Since a snap and swivel are not employed in this embodiment, to obtain another fish hooking means beside a single hook, all other hooks have to be inserted at the time the rig is made: a double hook, a treble hook or a horizontal unilateral fish hook with 2 or 3 horizontal prongs.

In FIG. 2 a c-weight 25 that could be removed and reinserted without cutting said leader, said c-weight 25 having a substantially c-shape that could slide along the leader for two-thirds of said leader, said c-weigh 25 having a first end 28, said first end 38 having a first bore 30 therethrough, said c-weight 25 having a second end, said second end 34 having a second bore 36 therethrough, said c-weight 25 having a gap from a first slot 32 to said first bore 30 on one side, on the opposite side said c-weight 25 having a second slot 38 to said second bore 36, beneath the second bore 36 is a hull hole 27 and a hull hole plug 39, and said c-weight 25 having a central semi-cylinder longitudinal groove 40 across a bottom of a hollow c-weight hull 26 therein for the option of allowing the c-weight 25 to be fixedly connected to said leader 13; said hollow c-weight hull 26 having an external central longitudinal groove 40 therein for allowing the c-weight 25 to be fixedly connected to said leader 13 the first slot 32 and the second slot 38 are inclined so as to hinder the leader 13 from working its way out of the removable sliding c-weight 25.

Again in FIG. 2 the hollow c-weight hull 26 is made of various volumes and of any substance including lead, lead with a skin from electroplating, spraying, dipping, lead with a coating of zinc orthophosphate, paint, latex, vinyl, nylon, wax, gum, rubber, rubber composite, fiberglass polymer, harden tar, with or without a sealer, polymer based composite material, and also a mixture thereof; and said removable sliding c-weight having a hollow c-weight hull made of any non-lead substance including different alloys of iron, steel, zinc, aluminum, tin, brass, bronze, ferrotungsten, and combinations thereof, and recyclable mixtures, plastic, synthetic containers, compressed wood, waxed products, epoxy, glue, rubber, and frozen fluids.

The third embodiment FIG. 3 has an elongated leader 13 constructed from monofilament fishing line. The elongated leader 13 has two opposite ends; an elongated leader having a leader hook end 14 that has a leader hook loop knot 15 and a leader line end 16 has a leader line loop 20. A leader hook loop knot 15 consists of a means of closing the loop around the fish hook 50. An elongated leader having a leader hook loop knot 15 is attached to a fish hook 50. A fish hooking means includes a single hook 50, a double hook, a treble hook or a horizontal unilateral fish hook with 2 or 3 horizontal prongs.

In FIG. 3 a leader line end 16 has a leader line loop 20 secured by a leader line loop knot 17 therein; a leader line loop knot 17 having leader line loop 20 that is opened yet having a means of closing the loop 20 to prevent objects from being caught therein; a leader line loop 20 created by a slip-knot means including a hangman's knot, scaffold knot, gallows knot, strangle knot, 4-turn slip knot, arbor knot, noose and slip-and-nip noose.

FIG. 3 has an elongated leader with two opposite ends, a leader hook end 14 and a leader line end 16. Said hook end 14 has a leader hook loop knot 15 therein, a first movement stop 22 frictionally connected to said leader 13 adjacent said line end 16, said first movement stop 22 is comprised of means of obstructing any passage beyond that point with a fixed object such as a crimped split shot, and said first movement stop 22 is inserted near the leader line loop knot 17. A second movement stop 24 frictionally connected to said leader 13. Said second movement stop 24 located between said first movement stop 22 and said leader hook end 14, and said second movement stop 24 is comprised of a means of obstructing a sliding weight. A second movement stop 22 is located approximately one-third of the way from said leader hook end 14, and approximately two-thirds of the distance from the line leader loop 20. FIG. 3 has a sinker attachment means of securing weight upon the leader 13 and a fish hooking means. A fish hooking means includes a single hook 50, a double hook, a treble hook or a horizontal unilateral fish hook with 2 or 3 horizontal prongs.

The fourth embodiment of the present invention of the new and improved bottom fish rigs with fish hooks 10 for fishing tackle has a sliding egg-sinker 55 with a fish hooking means, a single hook 50 is illustrated and will be described in FIG. 4. More particularly, a bottom fish rig with fish hook 10 has an elongated leader 13 that has two opposite ends, a leader hook end 14 and a leader line end 16. A leader hook end 14 has a leader hook loop 18 that is held securely by a crimped hook loop lug 19 therein: said lugs are crimped over 2 wire strands forming a loop.

A leader line end 16 has a leader line loop 20 that is attached to the fishing line from a fishing rod. A line end 16 has a leader line loop 20 that is held securely by a crimped line loop lug 21 therein. A first movement stop 22 is frictionally connected to said leader 13 adjacent said leader line end 16, said first movement stop 22 is comprised of means of obstructing any passage beyond that point with a fixed object such as a crimped split shot, said first movement stop 22 is inserted near the leader line loop lug 21; before crimping the leader line loop lug 21, the leader 13 was passed through an egg-sinker 55.

The second movement stop 24 is located approximately two-thirds of the distance of the bottom fish rig 13 and located between the line leader loop 20 and at the other end the leader hook loop 18. The second movement stop 24 is comprised of a crimped split shot. The second movement stop 24 is located on the leader 13 approximately one-third of the distance from the leader hook end 14.

Again in FIG. 4 one-third of a bottom fish rig 12 is a leader hook end 14. A swivel 48 is connected to the leader hook loop 18 by running the leader through the eye of the swivel 48 and having it secured by a crimped hook loop lug 19. A snap 46 is connected to the swivel 48. A fish hook 50 is attached with a snap 46 to a leader hook end 14.

The fifth embodiment, FIG. 5, has an elongated leader 13 having two opposite ends, a leader hook end 14 and a leader line end 16. Said hook end 14 has a leader hook loop 18 secured by a leader hook loop lug 19 therein. Said leader line end has a leader line loop secured by a leader line loop lug 19. Metallic lugs are crimped and fixably attached to a wire leader therein, said metallic lugs are crimped over 2 wire strands forming a loop. A first movement stop 22 is frictionally connected to said leader adjacent said line end, said first movement stop is comprised of means of obstructing any passage beyond that point with a fixed object such as a crimped split shot, said first movement stop 22 is inserted near the leader line loop lug 21. A second movement stop 24 frictionally connected to said leader 13, said second movement stop 24 located between said first movement stop 22 and said leader hook end 14, said second movement stop 24 is comprised of a means of obstructing further movement by a sliding sinker. Said second movement stop 24 is located approximately one-third of the way from said leader hook end 14, and approximately two-thirds of the distance from the line leader loop 20. An egg sinker 55 is sinker attachment means of securing weight upon the leader 13; and a fish hook 50 is a fish hooking means that is pre-attached to the leader hook loop lug 19.

Since a snap and swivel are not employed in this embodiment to obtain another fish hooking means beside a single hook, all other hooks have to be inserted at the time the rig is made: a double hook, a treble hook or a horizontal unilateral fish hook with 2 or 3 horizontal prongs.

FIG. 6 is the sixth embodiment which has an elongated leader 13 constructed from monofilament fishing line. The elongated leader 13 has two opposite ends; an elongated leader having a leader hook end 14 that has a leader hook loop knot 15 and a leader line end 16 has a leader line loop 20. A leader hook loop knot 15 consists of a means of closing the loop around the fish hook 50. An elongated leader having a leader hook loop knot 15 is attached to a fish hook 50. A fish hooking means includes a single hook 50, a double hook, a treble hook or a horizontal unilateral fish hook with 2 or 3 horizontal prongs.

In FIG. 6 a leader line end 16 has a leader line loop 20 secured by a leader line loop knot 17 therein; a leader line loop knot 17 having leader line loop 20 that is opened yet having a means of closing the loop 20 to prevent objects from being caught therein; a leader line loop 20 created by a slip-knot means including a hangman's knot, scaffold knot, gallows knot, strangle knot, 4-turn slip knot, arbor knot, noose and slip-and-nip noose.

FIG. 6 has an elongated leader having two opposite ends, a leader hook end 14 and a leader line end 16, said hook end 14 has a leader hook loop knot 15 therein. A first movement stop 22 frictionally connected to said leader 13 adjacent said line end 16, said first movement stop 22 is comprised of means of obstructing any passage beyond that point with a fixed object such as a crimped split shot, and said first movement stop 22 is inserted near the leader line loop knot 17. A second movement stop 24 frictionally connected to said leader 13. Said second movement stop 24 located between said first movement stop 22 and said leader hook end 14, said second movement stop 24 is comprised of a means of obstructing, said second movement stop 22 is located approximately one-third of the way from said leader hook end 14, and approximately two-thirds of the distance from the line leader loop 20. A sinker attachment means utilizes an egg sinker 55 thus securing weight upon the leader 13 and a fish hooking means. A fish hooking 15 means includes a single hook 50, a double hook, a treble hook or a horizontal unilateral fish hook with 2 or 3 horizontal prongs.

FIG. 1 to FIG. 6 have embodiments that use single fish hooks but are not limited thereto. The bottom fish rigs with fish hooks would still be effective with the most of the existing fishhooks sold in retail stores and referred to in the prior art. While fishing some fish will attack one color, while being indifferent to other colors. For example, shad have a history of striking gold hooks, some bass strike shiny objects. Producing different colored horizontal unilateral fish hooks having 2 or 3 barbs might be very effective against certain fish. Also horizontal unilateral fish hooks having 2 or 3 barbs have the option of being constructed of various metals or alloys that solidly join the shank, and weighted horizontal vertical fish hooks are constructed with additional metal that expands the thickness of the shank to assist in falling flat. The horizontal three-pronged hook could be made into hooks of many sizes, shapes, colors, and angles of the barbs, as well as but not limited to darts, plugs and other lures that may be used. Furthermore, a wide variety of hook sizes, different colored jigs and darts may be used with the bottom fish rig instead of the one described.

While embodiments in the drawings of the bottom fish rigs with fish hooks have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention.

The six embodiments described above have differences that affect their operation and the manner in which they would be used. Different sized snaps and swivels, loops of various shapes or twists could be formed, new knots found, and the sinkers and c-weights could be manufactured with different materials. For example, instead of lead, any suitable sturdy material or metal alloys could be a means of creating a sinker or solid c-weight including recycled metal, iron, tungsten, copper, nickel, silver, bismuth, aluminum, titanium, chrome, vanadium, cobalt, tin, brass, bronze, zinc plating, carbide, stainless steel or a combination of various metals and alloys. Beside metal other products could be used including glass, glass with plastic coating, concrete, substances to make ceramics, and different types of rock, stone, sand, silicone, bismuth, and including variations that could be heated, melted, and poured into molds; compounds like cement that are formed by chemical reactions, and synthetic plastic and rubber derivatives. Since only two types of sinkers have been utilized and illustrated, other sinkers could also be used effectively as a substitute in the six embodiments. Hopefully anyone who uses the new bottom fish rigs with fish hooks invention could be more successful than using the ordinary fish hook.

Notably, any person of ordinary skill in the pertinent art, science or area of the sport of fishing could make and use the invention without extensive experimentation and catch a fish. Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

What I claim as new is as follows:

1. A bottom fish rig with hook comprising:
an elongated leader having two opposite ends, a leader hook end and a leader line end, said hook end having a closed leader hook loop around a eye of a hook and secured by a leader hook loop knot therein, said line end having an opened leader line loop secured by an leader line loop knot therein,
a first movement stop frictionally connected to said leader adjacent said line end, said first movement stop is comprised of means of obstructing any passage beyond that point with a fixed object such as a crimped split shot, said first movement stop is inserted near a leader line loop knot;
a second movement stop frictionally connected to said leader, said second movement stop located between said first movement stop and said leader hook end, said second movement stop is comprised of a means of obstructing, said second movement stop is located approximately one-third of the way from said leader hook end, and approximately two-thirds of the distance from a line leader loop;
a sinker attachment means of securing weight upon a leader; and
a fish hooking means.

2. The bottom fish rig with hook of claim 1 wherein:
an elongated leader constructed from monofilament fishing line;
an elongated leader having a leader hook loop knot set tight and attached to a fish hook; and
a leader line loop knot having a leader line loop that is opened yet having a means of closing a loop to prevent objects from being caught therein;
a leader line loop created by a slip-knot means including a hangman's knot, scaffold knot, gallows knot, strangle knot, 4-turn slip knot, arbor knot, noose and slip-and-nip noose.

3. The bottom fish rig with hook of claim 1 wherein:
a sinker attachment means of securing an sliding egg-sinker that is connected to a leader.

4. The bottom fish rig with hook of claim 1 wherein:
a sinker attachment means of securing a solid sliding c-weight upon a leader; a c-weight having a substantially c-shape made of three main parts, a first end that has a first bore therethrough, a c-weight hull in the central and lower middle section that connects with a first end and a second end, and a second end that has a second bore therethrough as a means to attach to a fishing line;
a sinker attachment means of securing an solid sliding c-weight upon the leader;
a solid sliding c-weight having central bores in said first end and said second end to allow said leader to slide freely; and
a solid sliding c-weight consisting of any suitable sturdy material or metal alloys could be a means of creating a sinker or solid c-weight including recycled metal, iron, tungsten, copper, nickel, silver, bismuth, aluminum, titanium, chrome, vanadium, cobalt, tin, brass, bronze, lead, zinc plating, carbide, stainless steel or a combination of various metals and alloys; and
a solid sliding c-weight consisting of other products that could be used including glass, glass with plastic coating, concrete, substances to make ceramics, and different types of rock, stone, sand, silicone, bismuth, and including variations that could be heated, melted, and poured into molds; compounds like cement that are formed by chemical reactions, and synthetic plastic and rubber derivatives.

5. The bottom fish rig with hook of claim 1 wherein:
a fish hooking means including a single hook, a double hook, a treble hook or a horizontal unilateral fish hook with 2 or 3 horizontal prongs.

6. A bottom fish rig with hook of claim 1 wherein:
the leader hook loop is formed by a lug therein, and the leader line loop is formed by a lug therein.

7. A bottom fish rig with hook comprising:
an elongated leader having two opposite ends, a leader hook end and a leader line end, said hook end having a leader hook loop secured by a leader hook loop lug therein, said leader line end having a leader line loop secured by a leader line loop lug, said lugs are metallic and crimped and fixably attached to a wire leader therein, said lugs are crimped over 2 wire strands forming a loop;
a first movement stop frictionally connected to said leader adjacent said line end, said first movement stop is comprised of means of obstructing any passage beyond that point with a fixed object such as a crimped split shot, said first movement stop is inserted near the metallic leader line loop lug;
a second movement stop frictionally connected to said leader, said second movement stop located between said first movement stop and said leader hook end, said second movement stop is comprised of a means of obstructing, said second movement stop is located approximately one-third of the way from said leader hook end, and approximately two-thirds of the distance from the line leader loop;
a sinker attachment means of securing weight upon the leader; and
a fish hooking means.

8. The bottom fish rig with hook of claim 7 wherein:
a sinker attachment means of securing an sliding egg-sinker that is connected to a leader.

9. The bottom fish rig with hook of claim 7 wherein:
a c-weight that could be removed and reinserted without cutting said leader, said c-weight having a substantially c-shape that could slide along the leader for two-thirds of said leader, said c-weight having a first end, said first end having a first bore therethrough, said c-weight having a second end, said second end having a second bore therethrough, said c-weight having a gap from a first slot to said first bore on one side, on the opposite side said c-weight having a second slot to said second bore, beneath the second bore is a hull hole and a hull hole plug; the hull hole plug stops material from entering and leaving the hollow c-weight hull;
beneath the second bore is a hull hole and a hull hole plug, and said c-weight having a central semi-cylinder longitudinal groove across a bottom of a hollow c-weight hull therein for the option of allowing the c-weight to be fixedly connected to said leader;
said hollow c-weight hull having an external central longitudinal groove therein for allowing the c-weight to be fixedly connected to said leader.
the first slot and the second slot are inclined so as to hinder the leader from working its way out of the removable sliding c-weight.

10. In combination, the bottom fish rig with hook of claim 9 wherein:
the hollow c-weight hull is made of various volumes and of any substance including lead, lead with a skin from electroplating, spraying, dipping, lead with a coating of zinc orthophosphate, paint, latex, vinyl, nylon, wax, gum, rubber, rubber composite, fiberglass polymer, harden tar, with or without a sealer, polymer based composite material, and also a mixture thereof; and
said removable sliding c-weight having a hollow c-weight hull made of any non-lead substance including different alloys of iron, steel, zinc, aluminum, tin, nickel, cooper, brass, bronze, ferrotungsten, and combinations thereof, and recyclable mixtures, plastic, synthetic containers, compressed wood, waxed products, epoxy, glue, rubber, and frozen fluids.

11. The bottom fish rig with hook of claim 7 wherein:
a fish hooking means including a single hook, a double hook, a treble hook or a horizontal unilateral fish hook with 2 or 3 horizontal prongs.

12. A bottom fish rig with hook of claim 7 wherein:
the leader hook loop is formed by a knot therein, and the leader line loop is formed by a knot therein.

13. A bottom fish rig with hook comprising:
an elongated leader having two opposite ends, a leader hook end and a leader line end, said hook end having a leader hook loop secured by a leader hook loop lug therein, said line end having a leader line loop leader secured by a leader line loop lug, said lugs are crimped over 2 wire strands forming a loop;
a first movement stop frictionally connected to said leader adjacent said line end, said first movement stop is comprised of means of obstructing any passage beyond that point with a fixed object such as a crimped split shot, said first movement stop is inserted near the leader line loop lug;
a second movement stop frictionally connected to said leader, said second movement stop located between said first movement stop and said leader hook end, said second movement stop is comprised of a means of obstructing, said second movement stop is located approximately one-third of the way from said leader hook end, and approximately two-thirds of the distance from the line leader loop;
a sinker attachment means of securing weight upon the leader;
a swivel connected to said leader hook eye loop;
a snap connected to said swivel; and
fish hooking means.

14. The bottom fish rig with hook of claim 13 wherein:
a sinker attachment means of securing an sliding egg-sinker that is connected to a leader.

15. The bottom fish rig with hook of claim 13 wherein:
a c-weight that could be removed and reinserted without cutting said leader, said c-weight having a substantially c-shape that could slide along the leader for two-thirds of said leader, said c-weight having a first end, said first end having a first bore therethrough, said c-weight having a second end, said second end having a second bore therethrough, said c-weight having a gap from a first slot to said first bore on one side, on the opposite side said c-weight having a second slot to said second bore.

16. The bottom fish rig with hook of claim 13 wherein:
a fish hooking means including a single hook, a double hook, a treble hook or a horizontal unilateral fish hook with 2 or 3 horizontal prongs.

17. A bottom fish rig with hook of claim 13 wherein:
the leader hook loop is formed by a knot therein, and the leader line loop is formed by a knot therein.

18. A bottom fish rig with hook of claim 13 wherein:
said a sinker attachment means consisting of the egg-sinker and removable sliding c-weight; and
a sinker attachment means being made of any suitable sturdy material or metal alloys that could be a means of creating a solid c-weight or egg-sinker including recycled metals, iron, tungsten, copper, nickel, silver, bismuth, aluminum, titanium, chrome, vanadium, cobalt, tin, brass, bronze, lead, zinc plating, carbide, stainless steel or a combination of various metals and alloys;
a sinker attachment means being a sinker or removable sliding c-weight made of any other products including glass with or without plastic coating, concrete, substances to make ceramics, and different types of rock, stone, sand, silicone, bismuth, and including variations that could be heated, melted, and poured into molds; compounds like cement that are formed by chemical reactions, and synthetic plastic and rubber derivatives.
